(19) United States
(12) Patent Application Publication
(10) Pub. No.: US 2020/0174299 A1
(43) Pub. Date: Jun. 4, 2020

(54) DISPLAY DEVICE

(71) Applicant: SHARP KABUSHIKI KAISHA, Sakai City, Osaka (JP)

(72) Inventors: YOUHEI NAKANISHI, Sakai City, Osaka (JP); MASAYUKI KANEHIRO, Sakai City, Osaka (JP)

(21) Appl. No.: 16/636,431

(22) PCT Filed: Jul. 30, 2018
(86) PCT No.: PCT/JP2018/028401

§ 371 Date: Feb. 4, 2020

(30) Foreign Application Priority Data
Aug. 4, 2017 (JP) 2017-151717

(51) Int. Cl. G02F 1/13363; F21V 8/00; G02F 1/1335; G02F 1/13357; G02F 1/1337

(52) U.S. Cl. CPC G02F 1/13363; G02B 6/0051; G02F 1/133536; G02F 1/133514; G02F 1/133621; G02F 2001/133637; G02F 2413/05; G02F 2202/36; G02F 2413/01; G02F 2001/133614; G02F 1/1337

(57) ABSTRACT

A display device according to the present invention includes: a first substrate; a second substrate; a liquid crystal layer disposed between the first substrate and the second substrate; a light wavelength conversion layer disposed over the second substrate; a first polarizing plate disposed under the first substrate; a second polarizing plate disposed between the second substrate and the light wavelength conversion layer; and an optical compensation member disposed between the first substrate and the first polarizing plate and/or between the second substrate and the second polarizing plate.

### TECHNICAL FIELD

The present invention relates to a display device and, more specifically, to a display device including a layer that converts the wavelength of light incident on a liquid crystal panel.

### BACKGROUND ART

Liquid crystal displays perform gradation display by controlling, as desired, the amount of transmitted light in such a manner that the birefringence index of a liquid crystal layer disposed between polarizing plates is changed in accordance with the voltage applied across the liquid crystal layer. Every picture element includes pixels of three colors, namely, red pixels, green pixels, and blue pixels. These pixels may be individually subjected to gradation control, which in turn enables display with a high degree of color reproduction. The liquid crystal display may be provided with yellow pixels in addition to pixels of the three colors.

The refractive indices of liquid crystals are anisotropic. The refractive index of the liquid crystal layer as determined on the optical path extending from a backlight to a viewer thus varies depending on the direction in which the liquid crystal display is viewed. Such a conventional liquid crystal display exhibits viewing angle characteristics arising from the anisotropy of the refractive index of the liquid crystal layer. The angle formed by polarization axes of polarizing plates disposed respectively over and under the liquid crystal layer varies depending on the direction in which the liquid crystal display is viewed. The relationship between the voltage applied to the liquid crystal and the transmittance may thus vary depending on the direction in which the liquid crystal display is viewed, and as a result, the viewing angle characteristics are exhibited. Due to the viewing angle characteristics, display quality may suffer when the liquid crystal display is viewed in a certain direction.

Disposing a phase difference film appropriately between the liquid crystal layer and a polarizing plate to improve the visual angle characteristics compensates for the anisotropy of the refractive index of the liquid crystal panel when a display surface of the liquid crystal display is viewed obliquely. Such techniques by which the relationship between the voltage applied to the liquid crystal and the transmittance is kept constant irrespective of the direction in which the liquid crystal display is viewed are disclosed.

A selection from the aforementioned phase difference film and other optical compensations films may be made appropriately in accordance with the display mode of the liquid crystal display that is to include the selected optical compensation film. For example, PTL 1 and PTL 2 disclose optical compensation films applicable to liquid crystal displays whose display mode is the IPS mode.

### CITATION LIST

### Patent Literature

PTL 1: Japanese Unexamined Patent Application Publication No. 10-54982 (published on Feb. 24, 1998)

PTL 2: Japanese Unexamined Patent Application Publication No. 10-307291 (published on Nov. 17, 1998)

PTL 3: Japanese Unexamined Patent Application Publication No. 2013-231975 (published on Nov. 14, 2013)

### SUMMARY OF INVENTION

### Technical Problem

Liquid crystal displays are generally configured in such a manner that an optical compensation film is disposed between a liquid crystal layer and a polarizing plate to optically compensate for the visual angle characteristics of the liquid crystal layer and the visual angle characteristics of the polarizing plate that are exhibited when the liquid crystal display is viewed obliquely. The anisotropy of the refractive index of the liquid crystal layer, the anisotropy of the refractive index of the optical compensation film, and the polarizing plate each have wavelength dependence. It is thus preferred that optical compensation films suited respectively to the wavelength of light passing through red pixels, the wavelength of light passing through green pixels, and the wavelength of light passing through blue pixels, (and the wavelength of light passing through yellow pixels) be formed. However, it is more feasible, from a technological and cost point of view, to provide a common optical compensation film that is to be shared by all of the pixels. In this case, the optical compensation film may be designed to suit, for example, green pixels, which involve the highest main sensitivity. When the optical compensation film is designed to suit green pixels, the optical characteristics in red pixels and the optical characteristics in blue pixels are not at the optimum values, and as a result, the visual angle compensation may be insufficient.

PTL 3 describes a liquid crystal display in which light emitted by a backlight and transmitted through a liquid crystal layer passes through a birefringence functional layer capable of optical compensation and then passes through a color filter and a polarizing plate. Unfortunately, PTL 3 may not be able to completely eliminate the wavelength dependence of the refractive index associated with light transmitted through the birefringence functional layer. For the aforementioned reasons, the visual-angle characteristics compensation in this case may be insufficient.

### Solution to Problem

To solve the aforementioned problem, a display device according to an aspect of the present invention includes: a first substrate; a second substrate disposed over the first substrate; a liquid crystal layer disposed between the first substrate and the second substrate; a light wavelength conversion layer disposed over the second substrate; a first polarizing plate disposed under the first substrate; a second polarizing plate disposed between the second substrate and the light wavelength conversion layer; and an optical compensation member disposed between the first substrate and the first polarizing plate and/or between the second substrate and the second polarizing plate.

### Advantageous Effects of Invention

According to an aspect of the present invention, single-wavelength light enters pixels constituting a picture element, where the common optical compensation film is provided to compensate for visual angle characteristics of the liquid crystal layer. The light then enters the light wavelength conversion layer, where the light is converted into colors. A liquid crystal display having wide viewing angle characteristics comparable to those obtained with single wavelength light is provided accordingly.

### BRIEF DESCRIPTION OF DRAWINGS

FIG. 1 schematically illustrates a display device according to Embodiment 1 of the present invention.

FIG. 2 is a flowchart of the procedure for producing the display device according to Embodiment 1 of the present invention.

FIG. 3 schematically illustrates a display device according to Comparative Embodiment.

FIG. 4 includes graphs that give a comparison of effects produced by the display device according to Embodiment 1 of the present invention to effects produced by the display device according to Comparative Embodiment.

FIG. 5 schematically illustrates a display device according to Embodiment 2 of the present invention.

FIG. 6 schematically illustrates a display device according to Embodiment 3 of the present invention.

FIG. 7 is a sectional process chart of the procedure for forming orientation films to be included in a display device according to Embodiment 4 of the present invention.

FIG. 8 schematically illustrates a display device according to Embodiment 5 of the present invention.

### DESCRIPTION OF EMBODIMENTS

### Embodiment 1

The direction in which a display surface of a display device is viewed from a backlight unit of the display device is herein defined as an upward direction.

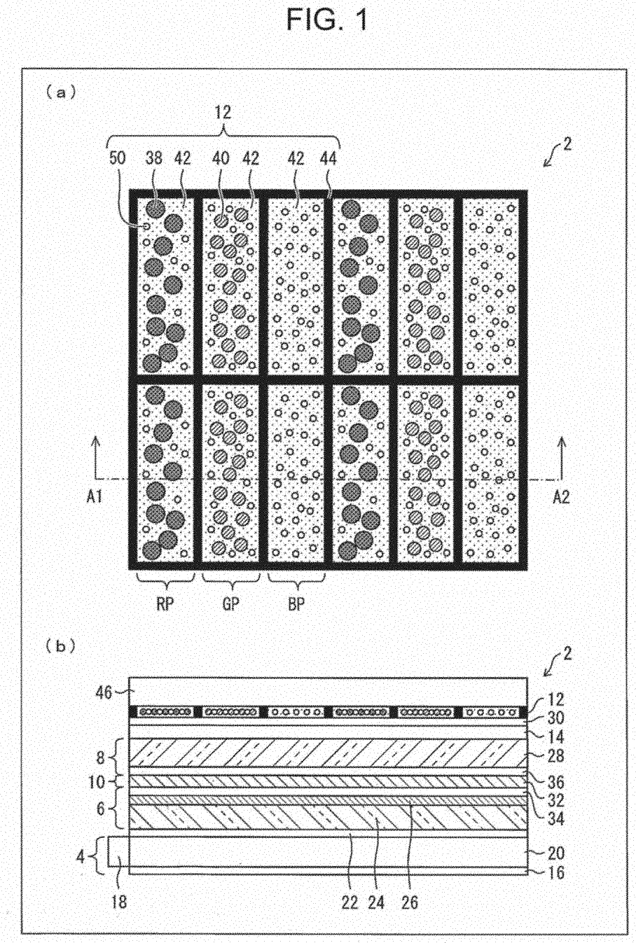

FIG. 1 schematically illustrates a display device 2 according to a first embodiment. FIG. 1(a) illustrates an upper surface of the display device 2, and FIG. 1(b) is a sectional view taken along line A1-A2 in the direction of the arrows in FIG. 1(a). It should be noted that FIG. 1(a) illustrates the upper surface of the display device 2 seen through a cover glass 46 on a light wavelength conversion. layer 12.

As illustrated in FIG. 1, the display device 2 according to the present embodiment includes a backlight unit 4, a first substrate 6, a second substrate 8, a liquid crystal layer 10, the light wavelength conversion layer 12, and an optical compensation member 14.

The backlight unit 4 includes a reflecting plate 16, a blue-light-emitting element 18, and a light guide plate 20. The light guide plate 20 including the blue-light-emitting element 18 in an end portion thereof is formed on an upper surface of the reflecting plate 16. The blue-light-emitting element 18 may be, for example, a blue LED that emits blue light with a peak wavelength of 450 nm. The blue light projected onto the light guide plate 20 by the blue-light-emitting element 18 is then transmitted through upper and lower surfaces of the light guide plate 20. Each of the upper and lower surfaces of the Light guide plate 20 may have a microstructure that is designed to guide projected light to the outside of the light guide plate 20. The upper and lower surfaces may have different microstructure patterns. The blue light emitted from the lower surface of the light guide plate 20 is reflected by the reflecting plate 16 and transmitted in the upward direction. A diffuser film (not illustrated) may be disposed on the upper surface of the light guide plate 20 to diffuse, in the front direction of the display device 2, light emitted from the upper surface of the light guide plate 20. A prism film (not illustrated) may also be disposed on the upper surface of the light guide plate 20 to collect, in the front direction of the display device 2, light emitted from the upper surface of the light guide plate 20.

The first substrate 6 is also referred to as an array substrate and is formed by disposing scanning electrodes and signal electrodes disposed on a first glass substrate 24 and by disposing thin film transistors (TFTs) at intersection points of traces extending from the electrodes. Potentials are applied to pixel electrodes in such a manner that signals are transmitted from signal electrodes via TFTs selected at corresponding scanning electrodes. A first polarizing plate 22 is bonded to a lower surface of the first substrate 6.

The second substrate 8, which is disposed over the first substrate 6, includes a second glass substrate 28 and is disposed opposite to the first substrate 6 with the liquid crystal layer therebetween. A second polarizing plate 30 is disposed on an upper surface of the second substrate 8. In the present embodiment, the first polarizing plate 22 and the second polarizing plate 30 are disposed in such a manner that light transmitted through the first polarizing plate 22 and light transmitted through the second polarizing plate 30 are linearly polarized, with their respective polarization axes being substantially perpendicular to each other. The first polarizing plate 22 and the second polarizing plate 30 may be circular polarizing plates. In this case, light transmitted through the first polarizing plate 22 enters the liquid crystal layer while being circularly polarized.

The first polarizing plate 22 and the second polarizing plate 30 may be reflective polarizing plates. In particular, when the first polarizing plate 22 is a reflective polarizing plate, light reflected by the first polarizing plate 22 returns to the backlight unit 4 side and is then reflected by the reflecting plate 16 to return to the first polarizing plate 22. The polarization state of the reflected light changes while the reflected light passes twice through a diffuser plate and other components of the backlight unit 4. Consequently, part of the reflected light may pass through the first polarizing plate 22. The use of the reflective polarizing plate as the first polarizing plate 22 thus enables the display device 2 to improve the efficiency of light utilization.

A first orientation layer 34 is formed on the first substrate 6, and a second orientation layer 36 is formed on the second substrate 8. The liquid crystal layer 10 includes a liquid crystal 32 charged between the first substrate 6 and the second substrate 8. The liquid crystal 32, the first orientation layer 34, and the second orientation layer 36 each may be of the type designed as appropriate in accordance with the display mode of the display device 2. Other features such as the orientation direction of the first orientation layer 34 and the orientation direction of the second orientation layer 36 may also be determined as appropriate in accordance with the display mode of the display device 2.

As illustrated in FIG. 1(a), the light wavelength conversion layer 12 includes: a red phosphor 38 that converts blue light into red light; a green phosphor 40 that converts blue light into green light; a resin 42; and a shielding layer 44. As illustrated in FIG. 1(b), the light wavelength conversion layer 12 is disposed over the second substrate 8.

Phosphors are material that absorb energy from the outside and emit light. The posphors used in the present invention are materials that have the property of absorbing incident light and emitting fluorescent light whose wavelength is longer than the wavelength of the absorbed light. In particular, a material that converts blue light into green light or red light is preferably used in the present embodiment. Specifically, phosphors that may be used as the red phosphor 38 include: a nitride phosphor referred to as CASN and containing CaAlSiN₃:Eu as a principal component; and a fluoride phosphor referred to as KSF. Quantum dots may also be used as the red phosphor. Phosphors that may be used as the green phosphor 40 include SiAlON-based phosphors. Quantum dots may also be used as the green phosphor.

When being irradiated with blue light emitted by the backlight unit 4 and transmitted through the upper layers, the red phosphor 38 and the green phosphor 40 respectively emit, for example, red light with a peak wavelength ranging from about 600 nm to about 650 nm and green light with a peak wavelength ranging from about 500 nm to about 650 nm. The red phosphor 38 and the green phosphor 40 are dispersed in the resin 42, which is transparent.

The resin 42 is divided by the shielding layer 44, which is black, in such a way as to correspond to a plurality of pixel regions, namely, pixel regions RP, GP, and BP. The red phosphor 38 is dispersed in the resin 42 in the pixel region RP, and the green phosphor 40 is dispersed in the resin 42 in the pixel region GP. No phosphor is contained in the resin 42 in the pixel region BP. The positions of the pixel regions correspond to the positions of the aforementioned transistors, which are included in a TFT layer 26.

The resin 42 divided in such a way as to correspond to the individual pixel regions may contain a scattering agent 50, which scatters fluorescent light emitted by the red phosphor 38, fluorescent light emitted by the green phosphor 40, or blue light emitted by the backlight unit 4. Furthermore, the cover glass 46 may be bonded to an upper surface of the light wavelength conversion layer 12. Alternatively, the cover glass 46 with the light wavelength conversion layer 12 formed thereon may be bonded to the second substrate 6.

The optical compensation member 14 is formed between the first substrate 6 and the first polarizing plate 22 and/or between the second substrate 8 and the second polarizing plate 30. The optical compensation member 14 may be, for example, a phase difference plate. In this case, light emitted by the backlight unit 4 enters the optical compensation member 14, where the polarization characteristics of the light are changed. Optical compensation films best suited to corresponding display modes of the display device 2 are optically designed and are used as the optical compensation member 14.

In display modes such as the TN mode, the VA mode, and the OCB mode, the orientation of liquid crystal molecules in the liquid crystal layer 10 is controlled in such a manner that the potential of pixel electrodes on the first substrate 6 and the potential of a counter electrode on the second substrate 8 are controlled to apply a predetermined potential difference between each pixel electrode and the counter electrode. In display modes such as the IPS mode and the FFS mode, the orientation of liquid crystal molecules is controlled in such a manner that the potential of pixel electrodes formed on the first substrate 6 and the potential of a counter electrode formed on the first substrate 6 are controlled to apply a predetermined potential difference between each pixel electrode and the counter electrode. Thus, the transmittance of blue light emitted by the backlight unit 4 may be controlled for each pixel; that is, the ratio of light transmitted through the second polarizing plate 30 to the incident on the first polarizing plate 22 may be controlled for each pixel.

Light emitted by the backlight unit 4 and transmitted through the first polarizing plate 22 and the second polarizing plate 30 is monochromatic blue light. Naturally, light passing through the liquid crystal layer 10 and the optical compensation member 14 is monochromatic blue light. Even when the anisotropy of the refractive index of the liquid crystal layer 10 and the anisotropy of the refractive index of the optical compensation member 14 have wavelength dependence, it is only required that optical design be implemented in such a manner as to add optical compensation to blue light only.

Light transmitted through red pixels and light transmitted through green pixels are isotropically radiated by the red phosphor 38 and the green phosphor 40, respectively. It is thus not necessary to correct make a correction for visual angle characteristics. It is only required that optical compensation be added to only light transmitted through blue pixels.

The optical compensation provided by conventional liquid crystal display devices, which are configured to provide optical compensation for all wavelengths of visible light, may be optimized for only certain wavelengths. The visual angle characteristics associated with light of wavelengths for which optical compensation is not optimized may be incompletely compensated for, and as a result, the visual angle compensation may be incomplete. Meanwhile, the present invention eliminates the need to take the wavelength dependence into consideration and thus enables ideal optical compensation.

When the liquid crystal 32 is controlled in such a manner as to enable blue light emitted by the backlight unit 4 to pass through the pixel regions RP and GP, red light and green light are transmitted through the respective sites located on the display surface of the display device 2 and corresponding to the pixel regions RP and GF. When the liquid crystal 32 is controlled in such a manner as to enable blue light emitted by the backlight unit 4 to pass through the pixel region BP, blue light having undergone no wavelength conversion is transmitted through the site located on the display surface of the display device 2 and corresponding to the pixel region BP. The display device 2 is thus capable of controlling display in three primary colors: red, green, and blue in such a manner as to control, on a per-pixel region basis, the transmittance of blue light emitted by the backlight unit 4.

Red light and green light are emitted as fluorescent light and as scattered light having no angular dependence in emission direction. The scattering agent 50 may be used to scatter blue light, which is in turn emitted as scattered light having no angular dependence in emission direction. This enables a reduction in the viewing-angle dependence of the display light intensity of the display device 2.

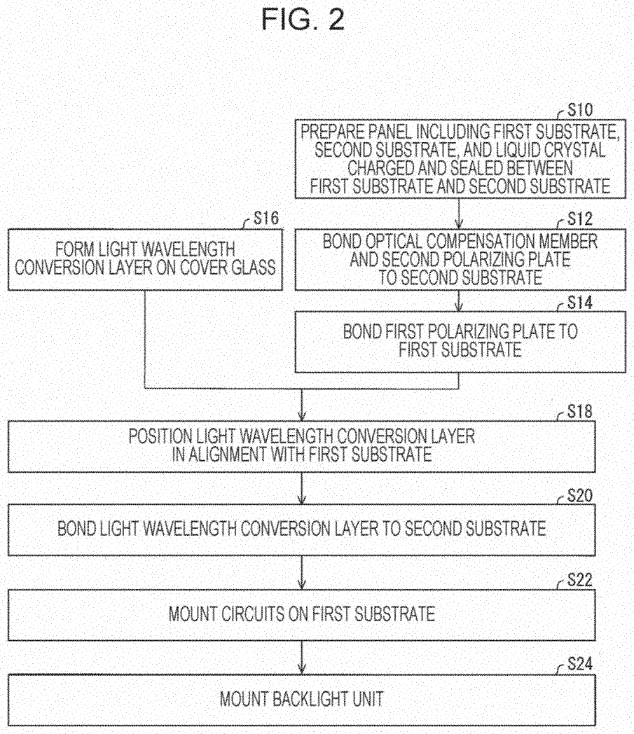

FIG. 2 is a flowchart of: the procedure for producing the display device 2 according to the present embodiment. Referring to FIG. 2, the following describes the procedure for producing the display device 2.

First, a panel including the first substrate 6, the second substrate 8, and the liquid crystal 32 charged and sealed between the substrates is prepared (Step S10). Step S10 may be performed by following the procedure applicable to conventional liquid crystal displays. For example, the step may include: forming the orientation layers 34 and 36 respectively on the first substrate 6 and the second substrate 8; coating the first substrate 6 or the second substrate 8 with a sealing material; dripping the liquid crystal 32 onto the substrate coated with the sealing material; and bonding the first substrate 6 and the second substrate 8 to each other. Alternatively, the step may include: bonding the first substrate 6 and the second substrate 8 to each other with a sealing material; making a hole in the sealing material and drawing vacuum between the first substrate 6 and the second substrate 8; and poring the liquid crystal 32 from the hole in the sealing material.

In the present embodiment, a color filter is formed neither on the first substrate 6 nor on the second substrate 8. Only a black matrix, which may be otherwise included in a color filter, may be formed on the first substrate 6 or the second substrate 8 in order to reduce the possibility that colors of adjacent pixels will be mixed.

Subsequently, the second polarizing plate 30 is bonded to the second substrate 8, and the first polarizing plate 22 is bonded to the first substrate 6. At least one of the first polarizing plate 22 and the second polarizing plate 30 in this state is integral with the optical compensation member 14. In the present embodiment, the optical compensation member 14 and the second polarizing plate 30 are bonded to an outer surface of the second substrate 8 (Step S12). The first polarizing plate 22 is then bonded to an outer surface of the first substrate 6 (Step S14).

The light wavelength conversion layer 12 is formed on the cover glass 46 in a separate step (Step S16). Subsequently, the light wavelength conversion layer 12 is positioned to be in alignment with the first substrate 6 in such a manner that the individual pixel regions in the light wavelength conversion layer 12 correspond to the individual pixels in the first substrate 6 (Step S18). The light wavelength conversion layer 12 is then bonded to the second substrate 8 (Step S20). Subsequently, components such as circuits are mounted on a terminal portion of the first substrate 6 (Step S22). The backlight unit 4 is then mounted (Step S24) to complete the production of the display device 2.

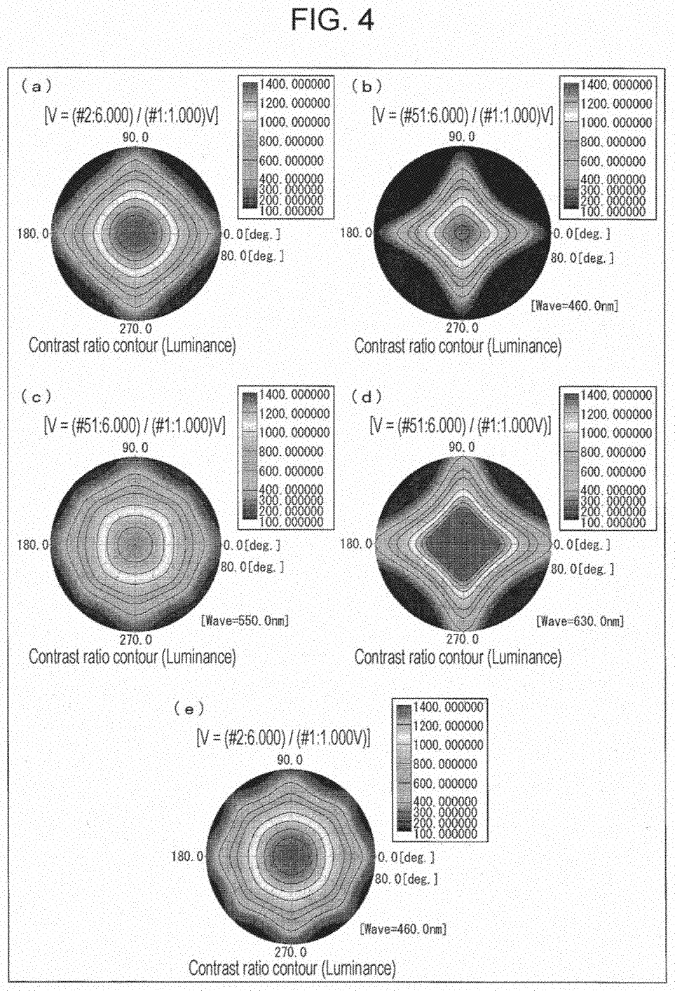

Referring to FIGS. 2 and 4, the following describes effects produced by the display device 2 according to the present embodiment.

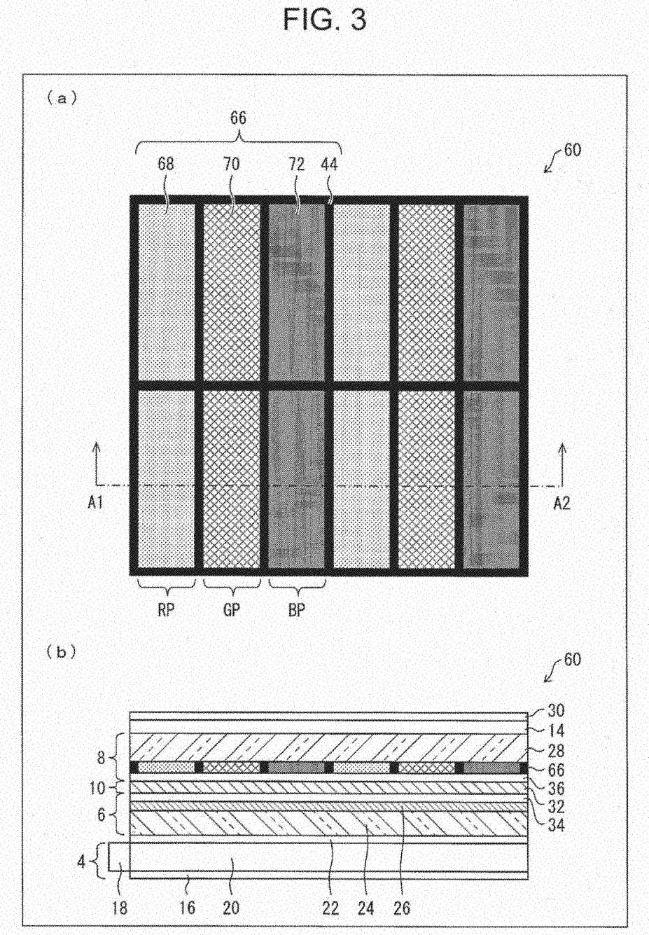

FIG. 3 schematically illustrates a display device 60 according to Comparative Embodiment. FIG. 3(a) illustrates an upper surface of the display device 60, and FIG. 3(b) is a sectional view taken along line A1-A2 in the direction of the arrows in FIG. 3(a). It should be noted that FIG. 3(a) illustrates the upper surface of the display device 60 seen through the second substrate 8 on a color filter 66 and through the optical compensation member 14 over the color filter 66.

The configuration of the display device 60 differs from the configuration of the display device 2 in that the display device 60 includes the color filter 66. The color filter 66 includes a red color filter 68, a green color filter 70, and a blue color filter 72 respectively in the pixel regions RP, GP, and BP separated by the shielding layer 44. The display device 60 includes the color filter 66 disposed on the second substrate 8. The optical compensation member 14 of the display device 60 is disposed between the second substrate 8 and the second polarizing plate 30. In some practical cases, the optical compensation member 14 may be disposed between the first polarizing plate 22 and the first substrate 6. Both the first substrate 6 and the second substrate 8 may be provided with the optical compensation members 14.

FIG. 4 is provided to describe differences between the visual characteristics of the display device 2 and the visual characteristics of the display device 60. The center of each of FIGS. 4(a) to 4(e) indicates the contrast that is obtained when the corresponding liquid crystal display is viewed from the front. The luminance in the white display state, namely, the luminance at the highest gray level is divided by the luminance in a black display state, namely the luminance at the lowest gray level, and the resultant value is given as the contrast. In each of FIGS. 4(a) to 4(e), the farther away from the center the point concerned is, the more oblique the direction in which the corresponding liquid crystal display is viewed is. In each of FIGS. 4(a) to (e), the outermost periphery of the circle indicates the contrast that is obtained when the liquid crystal display is viewed in the direction forming an 80-degree angle with the direction normal to the substrate.

FIG. 4(a) illustrates examples of visual characteristics associated with the contrast provided by a conventional liquid crystal display. The liquid crystal is a vertical-alignment-mode liquid crystal display. The liquid crystal display has a display surface divided into four domains, and the visual angle characteristics are corrected for each domain. Such a conventional display includes, for example, a polarizing plate and an A-plate, which is an optical compensation film for improving the visual angle characteristics of the polarizing plate and is disposed in such a manner that the slow axis of the optical compensation film is orthogonal, to the absorption axis of the polarizing plate adjacent to the optical compensation film. The A-plate of the conventional liquid crystal display is overlaid with, for example, a C-plate, which is an optical compensation film that adds optical compensation to the liquid crystal layer. A liquid crystal panel is disposed on the C-plate. The liquid crystal panel includes two substrates and a liquid crystal layer disposed between the substrates, and the liquid crystal panel is overlaid with a polarizing plate. As illustrated in FIG. 4(a), the contrast is maximized when the liquid crystal display is viewed from the front, and the contrast decreases with increasing angle between the front direction and the direction in which the liquid crystal display is viewed obliquely.

FIGS. 4(b) to (d) illustrate the visual characteristics associated with the contrast and provided when the aforementioned conventional liquid crystal display displays colors in the order of blue, green, and red. The liquid crystal layer, the optical compensation film, and the polarizing plate of the liquid crystal display have wavelength dependence. Thus, different visual angle characteristics are exhibited for different colors displayed by the liquid crystal display. The optical design of the liquid crystal display is typically tuned for the case of displaying green, which involves the highest main sensitivity. This provides almost ideal visual angle characteristics for green light. When the colors blue and red are displayed, however, the reduction in the contrast obtained at a 45-degree angle with respect to the display surface is comparatively large. When the display surface is viewed obliquely, the liquid crystal display in the normal display state involves not only a decrease in contrast but also color representation in which there is a predominance of green.

FIG. 4(e) illustrates visual angle characteristics exhibited for only light with a wavelength of 460 nm by the liquid crystal display. Each layer of the liquid crystal display concerned in FIG. 4(e) has wavelength dependence and is thus optically designed to provide the widest viewing angle at a wavelength of 460 nm. It should be noted that the configuration of the liquid crystal display concerned in FIG. 4(e) is identical to the configuration of the liquid crystal displays concerned in FIGS. 4(a) to 4(d).

For the reasons described with regard to FIGS. 4(a) to 4(d), the aforementioned problems associated with the visual angle characteristics arise in the display device 60, which is a conventional display. In the display device 2, meanwhile, only blue light passes through the liquid crystal layer, the optical compensation film, and the polarizing plate. The blue light then undergoes wavelength conversion in the light wavelength conversion layer 12. Substantially isotropic emittance of green light and red light from phosphors enables the display device 2 to exhibit close-to-ideal visual angle characteristics. Although blue light is not isotropically emitted, the visual angle characteristics associated with blue light are corrected by the optical compensation member 14, and the optical characteristics associated with blue light are thus rendered close to the optical characteristics associated with green light and to the optical characteristics associated with red light.

In the present embodiment, the scattering agent 50 is contained in the resin 42 in the pixel region BP, which is included in the light wavelength conversion layer 12 and allows blue light emitted from the backlight unit 4 to pass therethrough. Blue light emitted from the backlight unit 4 is thus scattered in the pixel region BP, and the visual characteristics of the blue light are rendered close to the visual angle characteristics of red light transmitted through the pixel region RP and the visual angle characteristics of green transmitted through the pixel region. GP.

### Embodiment 2

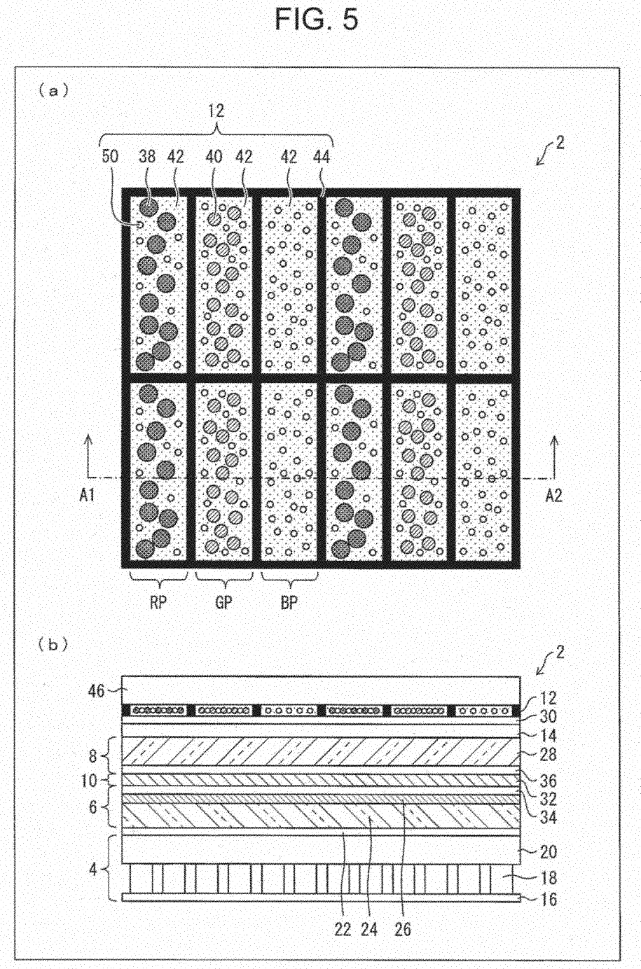

FIG. 5 schematically illustrates a display device 2 according to a second embodiment. FIG. 5(a) illustrates an upper surface of the display device 2, and FIG. 5(b) is a sectional view taken along line A1-A2 in the direction of the arrows in FIG. 5(a). It should be noted that FIG. 5(a) illustrates the upper surface of the display device 2 seen through the cover glass 46 on the light wavelength conversion layer 12.

The difference between the display device 2 according to the present embodiment and the display device 2 according to the aforementioned embodiment is only in the configuration of the backlight unit 4. The backlight unit 4 includes a plurality of blue-light-emitting elements 18 disposed between the reflecting plate 16 and a diffuser plate 21. The plurality of blue-light-emitting elements 18 may be disposed two-dimensionally on the reflecting plate 16, in other words, on a lower surface of the diffuser plate 21. Light emitted by the plurality of blue-light-emitting elements 18 is projected in the upward direction through a lower surface of the diffuser plate 21. Features such as control of the pixel regions through which light is transmitted and the principle on which blue light is converted may be identical to the relevant features of the display device 2 according to the aforementioned embodiment.

As with the display device 2 according to the aforementioned embodiment, the display device 2 according to the present embodiment produces the effects that have been described in comparison with the effects produced by the display device according to Comparative Embodiment. In addition, the display device 2 according to the present embodiment enables individual control of currents flowing through the respective blue-light-emitting elements 18 and is thus capable of controlling the radiant intensity of each of the plurality of blue-light-emitting elements 18 separately in accordance with the light and shade of an image. The display device 2 according to the present embodiment enables local dimming accordingly and is thus capable of displaying an image higher in contrast than an image displayed by the display device 2 according to the aforementioned embodiment.

Furthermore, the display device 2 according to the present embodiment enables local dimming and a wider color reproduction range at the same time through, for example, the use of quantum dots as phosphors.

The wider color reproduction range may be achieved, for example, by incorporating a conventional liquid crystal panel having a color filter into a backlight unit that includes, in place of a diffuser sheet, a phosphor sheet containing a phosphor capable of emitting green light and a phosphor capable of emitting red light. In particular, a quantum dot (QD) film containing quantum dots as phosphors provides an emission spectrum with a narrow half-value width, and the resultant color reproduction range is comparatively wide.

When the QD film is included in a backlight unit supporting local dimming, the angle at which light enters the QD film varies in accordance with the distance between an LED in the backlight unit and a quantum dot. These variations produce nonuniformity in the lengths of the optical paths between the LEDs in the backlight unit and the quantum dots, and the optical conversion rate changes accordingly. Consequently, light at a position close to an LED and light at a position some distance from the LED may not be equal in wavelength. This problem makes it difficult to provide a wider color reproduction range in combination with local dimming.

The aforementioned problem associated with nonuniformity in the length of the optical paths may be averted by the present embodiment, in which light enters the individual pixels in nearly uniform directions.

### Embodiment 3

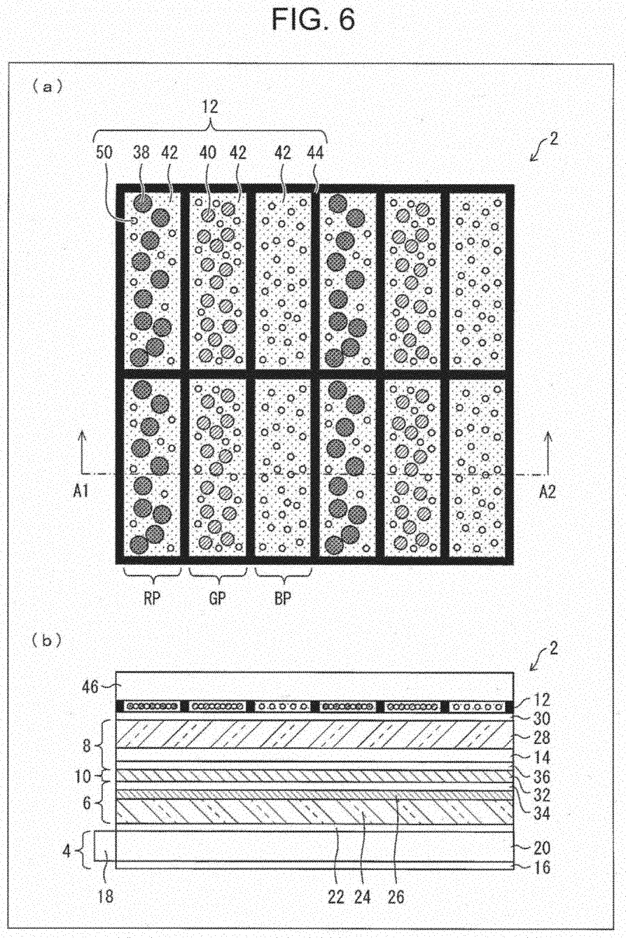

FIG. 6 schematically illustrates a display device 2 according to a third embodiment. FIG. 6(a) illustrates an upper surface of the display device 2, and FIG. 6(b) is a sectional view taken along line A1-A2 in the direction of the arrows in FIG. 6(a). It should be noted that FIG. 6(a) illustrates the upper surface of the display device 2 seen through the cover glass 46 on the light wavelength conversion layer 12. The display device 2 according to the embodiment 1 differs from the display device 2 according to the aforementioned embodiment only in that the optical compensation member 14 is formed between the liquid crystal layer 10 and the second substrate 8.

The display device 2 according to the present embodiment is configured in such a manner that light emitted by the backlight unit 4 and transmitted through the first polarizing plate 22, the first substrate 6, and then the liquid crystal layer 10 passes through the optical compensation member 14 formed on an inner surface of the second substrate 8. Subsequently, the light passes through the second polarizing plate 30 and the light wavelength conversion layer 12 and is then seen by the viewer.

The following describes the procedure for producing the display device 2.

First, the optical compensation member 14 is formed on the second substrate 8. A black matrix and an electrode may be additionally formed as necessary. Subsequently, orientation films are formed respectively on the first substrate 6 and the second substrate 8. A seal is applied to the first substrate 6 or the second substrate 8, and a predetermined amount of liquid crystal 32 is dripped. Subsequently, the orientation film on the first substrate 6 and the orientation film on the second substrate 8 are bonded face-to-face in a vacuum, and the seal is then hardened. Alternatively, after the first substrate 6 and the second substrate 8 are bonded to each other, the liquid crystal 32 may be charged between the first substrate 6 and the second substrate 8 in such a way as to be injected through a hole made in a sealing material.

Subsequently, the first polarizing plate 22 is bonded to an outer surface of the first substrate 6, and the second polarizing plate 30 is bonded to an outer surface of the second substrate 8. After that, the steps S16 to S24 described above are performed to produce the display device 2 according to the present embodiment.

### Embodiment 4

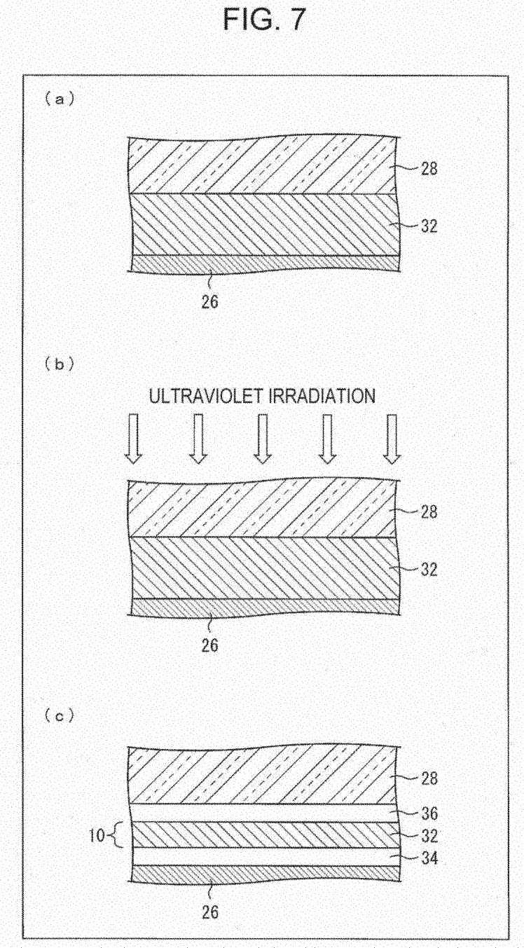

A display device 2 according to the present embodiment has the configuration identical to the configuration of the display device 2 according to the aforementioned embodiment. The optical compensation member 14 of the display device 2 according to the present embodiment is formed closer than the second substrate 8 to the inner surface. It is therefore preferred that no heating process be used to form orientation layers so that the properties of the optical compensation member 14 are not altered. In the present embodiment, orientation films are not formed on the corresponding substrates in advance. As illustrated in FIG. 7(a), a monomeric material is added to the liquid crystal 32 and the resultant mixture is charged between the substrates. Subsequently, the monomer contained in the liquid crystal is settled on the substrates and polymerized by means of ultraviolet irradiation as illustrated in FIG. 7(b), and the resultant polymer is formed into the orientation layers 34 and 36 illustrated in FIG. 7(c). The process of producing the display device 2 according to the present embodiment eliminates a heating process, which could otherwise alter the properties of the optical compensation member 14. The procedure for producing the display device 2 according to the present embodiment enables production of the display device 2 with enhanced production yield.

### Embodiment 5

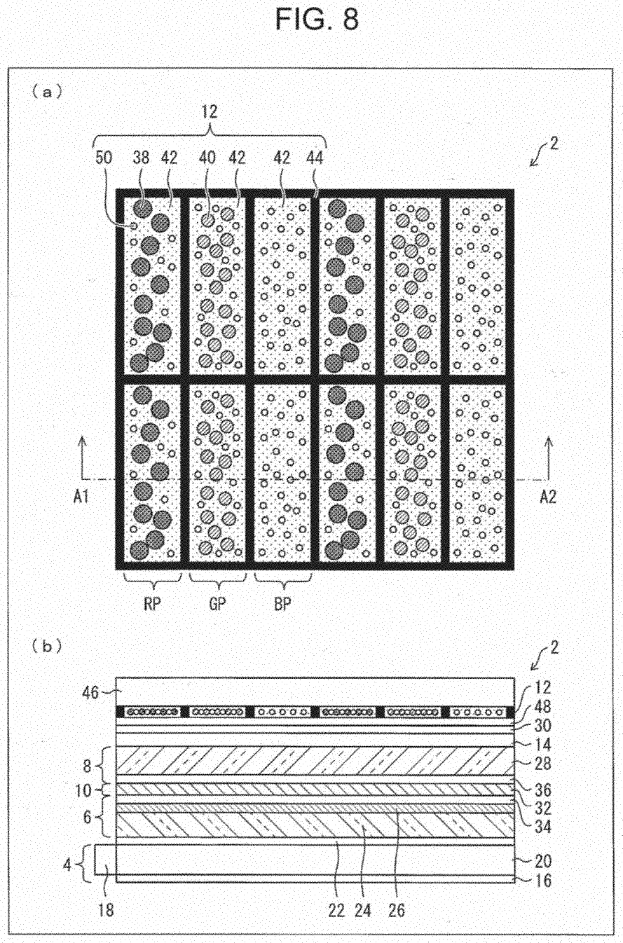

FIG. 8 schematically illustrates a display device 2 according to a fifth embodiment. FIG. 8(a) illustrates an upper surface of the display device 2, and FIG. 8(b) is a sectional view taken along line A1-A2 in the direction of the arrows in FIG. 8(a). It should be noted that FIG. 8(a) illustrates the upper surface of the display device 2 seen through the cover glass 46 on the light wavelength conversion layer 12.

The display device 2 according to the present embodiment differs from the display device 2 according to the embodiment 1 in that a blue color filter 48 is disposed between the light wavelength conversion layer 12 and the optical compensation member 14. The blue color filter 48 is an optical filter through which blue light are transmitted. The blue color filter 48 may be, for example, a band-pass filter or a low-pass filter. A color filter for blue pixels in a conventional liquid crystal display may be used as the blue color filter 48. The blue color filter 48 is formed between the light wavelength conversion layer 12 and the optical compensation member 14 in such a manner so as to extend from end to end or to correspond to the red pixel region RP and the green pixel region GP.

Phosphors in the light wavelength conversion layer 12 emit fluorescent light not only toward the cover glass 46 but also toward the optical compensation member 14, that is, the phosphors emit fluorescent light in all directions around them. The display device 2 according to the aforementioned embodiment is configured in such a manner that fluorescent light emitted in the downward direction by the red phosphor 38 and fluorescent light emitted in the downward direction by the green phosphor 40 are reflected by the reflecting plate 16. Part of the light reflected by the reflecting plate 16 passes through blue pixels. The light transmitted through the blue pixels may be mixed with green light or red light, and as a result, the chromaticity may be degraded.

In the present embodiment, light emitted by the phosphors toward the backlight is blocked by the blue color filter 48. This means that no part of light emitted by the phosphors is transmitted in the downward direction to be reflected back in the upward direction by the reflecting plate 16.

The display device 2 according to the present embodiment is configured in such a manner that only blue light emitted by the backlight unit 4 and blue light emitted by the phosphors pass through the optical compensation member 14. This configuration enables optical compensation irrespective of the wavelength dependence of the optical characteristics of the optical compensation member 14. More specifically, incoming light directed to the light wavelength conversion layer 12 is light of a single wavelength irrespective of which of the RGB pixels is to transmit the light. Thus, ideal optical compensation may be achieved. This eliminates the wavelength dependence of the optical compensation member 14 and improves viewing angle characteristics more easily.

### Conclusion

A display device according to Aspect 1 includes: a first substrate; a second substrate disposed over the first substrate; a liquid crystal layer disposed between the first substrate and the second substrate; a light wavelength conversion layer disposed over the second substrate; a first polarizing plate disposed under the first substrate; a second polarizing plate disposed between the second substrate and the light wavelength conversion layer; and an optical compensation member disposed between the first substrate and the first polarizing plate and/or between the second substrate and the second polarizing plate.

According to Aspect 2, the optical compensation member is a phase difference plate.

According to Aspect 3, a backlight that emits blue light is disposed under the first substrate.

According to Aspect 4, the light wavelength conversion layer includes: a pixel region including a red phosphor that emits red light; a pixel region including a green phosphor that emits green light; and a pixel region including no phosphor.

According to Aspect 5, a blue color filter is disposed between the light wavelength conversion layer and the optical compensation member.

According to Aspect 6, the blue color filter is disposed on the pixel region including the red phosphor and on the pixel region including the green phosphor.

According to Aspect 7, at least one of the first polarizing plate and the second polarizing plate is a reflective polarizing plate.

According to Aspect 8, an orientation layer disposed between the liquid crystal layer and the first substrate and an orientation layer disposed between the liquid crystal layer and the second substrate are provided.

According to Aspect 9, each of the orientation layers contains a polymer that functions as the orientation layers, the polymer being made by polymerizing, under ultraviolet irradiation, a monomer added to a liquid crystal.

According to Aspect 10, the backlight includes a light guide plate and a blue-light-emitting element that irradiates an edge of the light guide plate with light.

According to Aspect 11, the backlight includes a diffuser plate and a blue-light-emitting element that irradiates a lower surface of the diffuser plate with light.

According to Aspect 12, the light wavelength conversion layer contains quantum dots.

According to Aspect 13, the light wavelength conversion layer contains a scattering agent.

The present invention is not limited to the embodiments described above, and various alterations may be made within the scope of the appended claims. Embodiments obtained by combining the techniques of different embodiments as appropriate also fall within the technical scope of the present invention. Furthermore, combinations of the techniques of the embodiments may produce new technical features.

### REFERENCE SIGNS LIST

2 display device

4 backlight unit

6 first substrate

8 second substrate

10 liquid crystal layer

12 light wavelength conversion layer

14 optical compensation member

18 blue-light-emitting element

20 light guide plate

22 first polarizing plate

30 second polarizing plate

32 liquid crystal

34 first orientation layer

36 second orientation layer

38 red phosphor

40 green phosphor

48 blue color filter

1. A display device comprising:
a first substrate;
a second substrate disposed over the first substrate;
a liquid crystal layer disposed between the first substrate and the second substrate;
a light wavelength conversion layer disposed over the second substrate;
a first polarizing plate disposed under the first substrate;
a second polarizing plate disposed between the second substrate and the light wavelength conversion layer; and
an optical compensation member disposed between the first substrate and the first polarizing plate and/or between the second substrate and the second polarizing plate.

2. The display device according to claim 1, wherein the optical compensation member is a phase difference plate.

3. The display device according to claim 1, further comprising a backlight disposed under the first substrate to emit blue light.

4. The display device according to claim 3, wherein the light wavelength conversion layer includes: a pixel region including a red phosphor that emits red light; a pixel region including a green phosphor that emits green light; and a pixel region including no phosphor.

5. The display device according to claim 4, further comprising a blue color filter disposed between the light wavelength conversion layer and the optical compensation member.

6. The display device according to claim 5, wherein the blue color filter is disposed on the pixel region including the red phosphor and on the pixel region including the green phosphor.

7. The display device according to claim 1, wherein at least one of the first polarizing plate and the second polarizing plate is a reflective polarizing plate.

8. The display device according to claim 1, further comprising:
an orientation layer disposed between the liquid crystal layer and the first substrate; and
an orientation layer disposed between the liquid crystal layer and the second substrate.

9. The display device according to claim 8, wherein each of the orientation layers contains a polymer that functions as an orientation layer, the polymer being made by polymerizing, under ultraviolet irradiation, a monomer added to a liquid crystal.

10. The display device according to claim 3, wherein the backlight includes a light guide plate and a blue-light-emitting element that irradiates an edge of the light guide plate with light.

11. The display device according to claim 3, wherein the backlight includes a diffuser plate and a blue-light-emitting element that irradiates a lower surface of the diffuser plate with light.

12. The display device according to claim 1, wherein the light wavelength conversion layer contains quantum dots.

13. The display device according to claim 1, wherein the light wavelength conversion layer contains a scattering agent.
